(19) United States
(12) Patent Application Publication
(10) Pub. No.: US 2026/0249576 A1
(43) Pub. Date: Aug. 27, 2026

(54) ARTICLE OF FOOTWEAR

(71) Applicant: NIKE, Inc., Beaverton, OR (US)

(72) Inventors: Alison C. CHEW, Portland, OR (US); Sami M. FAKHOURI, Portland, OR (US); Timothy J. SLAMA, Beaverton, OR (US)

(73) Assignee: NIKE, Inc., Beaverton, OR (US)

(21) Appl. No.: 19/059,998

(22) Filed: Feb. 21, 2025

(51) Int. Cl. B29D 35/12; B29D 35/00

(52) U.S. Cl. CPC B29D 35/128; B29D 35/122; B29D 35/0018; B29D 35/0063

(57) ABSTRACT

A mold for manufacturing a sole structure for an article of footwear including a first end and a second end opposite the first end, a first edge and a second edge disposed opposite the first edge, and a plurality of chambers surrounding one or more cavities, where the plurality of chambers extend from the first end to the second end and from the first edge to the second edge.

### FIELD

The present disclosure relates generally to sole structures for articles of footwear, and more particularly, to a mold for manufacturing sole structures.

### BACKGROUND

This section provides background information related to the present disclosure which is not necessarily prior art.

Articles of footwear conventionally include an upper and a sole structure. The upper may be formed from any suitable material to receive, secure, and support a foot on the sole structure. The upper may cooperate with laces, straps, or other fasteners to adjust the fit of the upper around the foot. A bottom portion of the upper, proximate to a bottom surface of the foot, attaches to the sole structure.

A sole structure generally includes a layered arrangement extending between a ground surface and the upper. One layer of the sole structure includes an outsole that provides abrasion-resistance and traction with the ground surface. The outsole may be formed from rubber or other materials that impart durability and wear-resistance, as well as enhance traction with the ground surface. Another layer of the sole structure includes a midsole disposed between the outsole and the upper. The midsole provides cushioning for the foot and may be partially formed from a polymer foam material that compresses resiliently under an applied load to cushion the foot by attenuating ground-reaction forces. The midsole may additionally or alternatively incorporate a fluid-filled bladder to increase durability of the sole structure, as well as to provide cushioning to the foot by compressing resiliently under an applied load to attenuate ground-reaction forces. Sole structures may also include a comfort-enhancing insole or a sockliner located within a void proximate to the bottom portion of the upper, and a strobel attached to the upper and disposed between the midsole and the insole or sockliner.

Midsoles employing fluid-filled bladders typically include a bladder formed from two barrier layers of polymer material which are sealed or bonded together. The fluid-filled bladders are pressurized with a fluid such as air, and may incorporate tensile members within the bladder to retain the shape of the bladder when compressed resiliently under applied loads, such as during athletic movements. Generally, bladders are designed with an emphasis on balancing support for the foot and cushioning characteristics that relate to responsiveness as the bladder resiliently compresses under an applied load.

### BRIEF DESCRIPTION OF DRAWINGS

The drawings described herein are for illustrative purposes only of selected configurations and are not intended to limit the scope of the present disclosure.

FIG. 1 is a top perspective view of a mold for manufacturing a sole structure of an article of footwear;

FIG. 2 is a perspective view of a block for manufacturing a sole structure of an article of footwear;

FIG. 3 is a top perspective view of the mold of FIG. 1 coupled with the block of FIG. 2;

FIG. 4 is a zoomed in perspective view of the mold of FIG. 1 coupled with the block of FIG. 2; and

FIG. 5 is a perspective view of a sole structure manufacture with the mold of FIG. 1 and the block of FIG. 2.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first”, “second”, “third”, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In the discussion that follows, terms “about,” “approximately,” “substantially,” and the like, when used in describing a numerical value, denote a variation of +/−10% of that value, unless specified otherwise.

The present disclosure is directed to a mold 102 for creating portions of an article of footwear that provides unique underfoot cushioning and responsiveness during use. The mold 102 is formed of a first material. In an example, the first material is a foamed material.

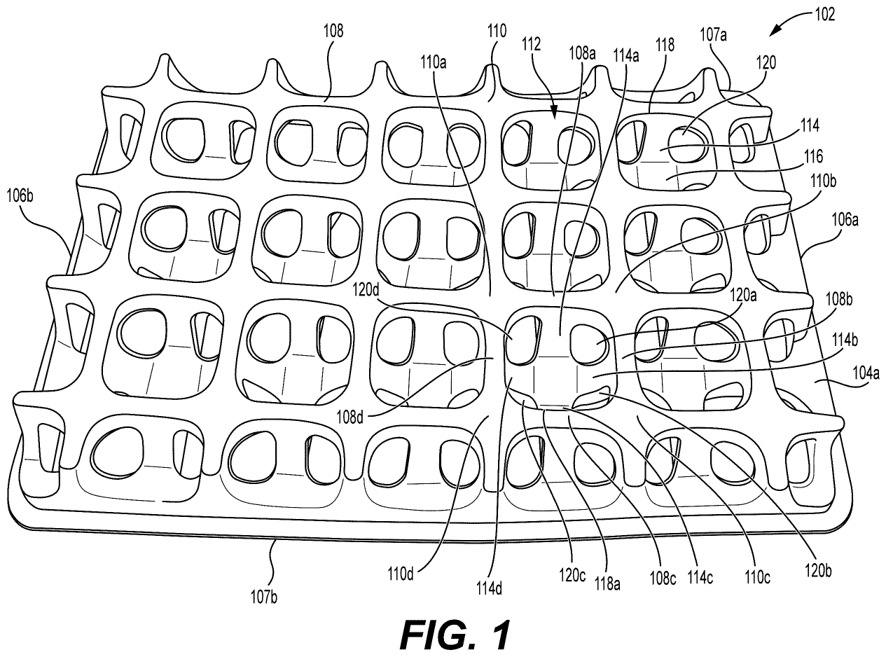

Referring to FIG. 1, the mold 102 includes a first (bottom) surface 104a and a second (top) surface (not shown) opposite the first surface. The mold 102 extends from a first end 106a to a second end 106b. In an example, the first end 106a is disposed in a plane that is offset from a plane of the second end 106b. In other words, the mold 102 may taper from the first end 106a to the second end 106b. For example, if the mold were resting on a flat surface, the first end 106a would be disposed in a plane that is different from a plane of the second end 106b. The mold 102 includes a first edge 107a and a second edge 107b. A portion of each of the first edge 107a and the second edge 107b disposed nearer the first end 106a is disposed in a plane that is offset from a plane of other portions of each of the first edge 107a and the second edge 107b disposed nearer the second end 106b. The mold 102 includes one or more ribs 108 extending from the first end 106a to the second end 106, and extending from the first edge 107a to the second edge 107b. The one or more ribs 108 extend from the first surface 104a of the mold 102 such that the one or more ribs 108 are disposed in a plane that is offset from a plane of the first surface 104a into the mold 102. In some examples, the one or more ribs 108 continuously extend from the first end 106a to the second end 106, and from the first edge 107a to the second edge 107b. As will be described in greater detail below, the one or more ribs 108 provide structure for the mold 102.

The one or more ribs 108 are interconnected between one or more bases 110. In an example, the one or more ribs 108 and the one or more bases 110 form a rectangular boundary surrounding one or more cavities 112. In some examples, the boundary of the one or more cavities 112 may be circular, ovular, rectangular, triangular, or any other desired shape. The mold 102 includes one or more posts 114 extending from the one or more ribs 108 into the respective cavity of the one or more cavities 112. The one or more posts 114 extend and are connected to a footing 116. In an example, the one or more ribs 108, coupled with the one or more bases 110, the one or more posts 114, and the footing 116 forms a chamber 118 of a plurality of chambers 118. The chamber 118 surrounds a respective cavity of the one or more cavities 112. The chamber 118 includes one or more openings 120. The one or more openings 120 may be disposed between respective posts 114 of the one or more posts 114. In an example, chambers 118 disposed nearer the first end 106a are disposed in a plane that is offset from a plane of chambers 118 disposed nearer the second end 106b. The chambers 118 being disposed in such a manner allows for ease of coupling or mating with additional parts, as described later.

An exemplary chamber is described for ease of discussion, but it is contemplated that each of the chambers 118 may be substantially similar. In an example, a first chamber 118a is shown surrounding a first cavity 112a. The first chamber 118a includes a first rib 108a, a second rib 108b, a third rib 108c, and a fourth rib 108d. The first chamber 118a includes a first base 110a, a second base 110b, a third base 110c, and a fourth base 110d. The first rib 108a extends between the first base 110a and the second base 110b. The second rib 108b extends between the second base 110b and the third base 110c. The third rib 108c extends between the third base 110c and the fourth base 110d. The fourth rib 108d extends between the fourth base 110d and the first base 110a. The first chamber 118a includes a first post 114a, a second post 114b, a third post 114c, and a fourth post 114d. The first chamber 118a includes an inner rim 115. The first post 114a extends from the first rib 108a to the footing 116. The second post 114b extends from the second rib 108b to the footing 116. The third post 114c extends from the third rib 108c to the footing 116. The fourth post 114d extends from the fourth rib 108d to the footing 116. In an example, the first chamber 118a is square in shape as the ribs 108a, 108b, 108c, and 108d extending between the respective bases 110a, 110b, 110c, and 110d. In some examples, the first chamber 118a may be ovular, rectangular, triangular, or any shape desired

In an example, the first chamber 118 a includes between about 1 and 12 posts 114. In some examples, the first chamber 118a includes between about 2 and 6 posts. In some examples, the first chamber 118 a includes four posts 114. In other examples, the first chamber 118a includes any number of posts 114 as desired. In an example, the first chamber 118a includes a rounded surface such that the footing 116 is rounded and each of the posts 114a, 114b, 114c, and 114d are rounded. In the example, the first chamber 118a is rounded such that when the mold 102 compresses other objects or molds, the second surface (not shown) of the first chamber 118a opposite the first surface 104a presses in a rounded manner to create a concave surface in the other object or mold.

A first opening 120a is disposed between the first post 114a and the second post 114b. A second opening 120b is disposed between the second post 114b and the third post 114c. A third opening 120c is disposed between the third post 114c and the fourth post 114d. A fourth opening 120d is disposed between the fourth post 114d and the first post 114a. In an example, each of the openings 120a, 120b, 120c, and 120d are circular in shape. In some examples, each of the openings 120a, 120b, 120c, and 120d may be ovular, rectangular, or square in shape. In some examples, some of the openings 120a, 120b, 120c, and 120d may have a first shape while other of the openings 120a, 120b, 120c, and 120d have a second shape. As will be described in greater detail below, respective portions of the chamber 118 are configured to engage with a block (i.e., a foam block).

As is shown in FIG. 1, one or more of the chambers 118 disposed along an outer periphery of the mold 102 at the first end 106a, the second end 106b, the first edge 107a, and the second edge 107b are partial chambers 118. In other words, the chambers 118 disposed at the first end 106a, the second end 106b, the first edge 107a, and the second edge 107b may have less posts 114 and openings 120 than chambers 118 disposed at interior portions of the mold 102. The partial chambers 118 disposed along the outer periphery of the mold 102 may include an interior portion exposed to the external environment.

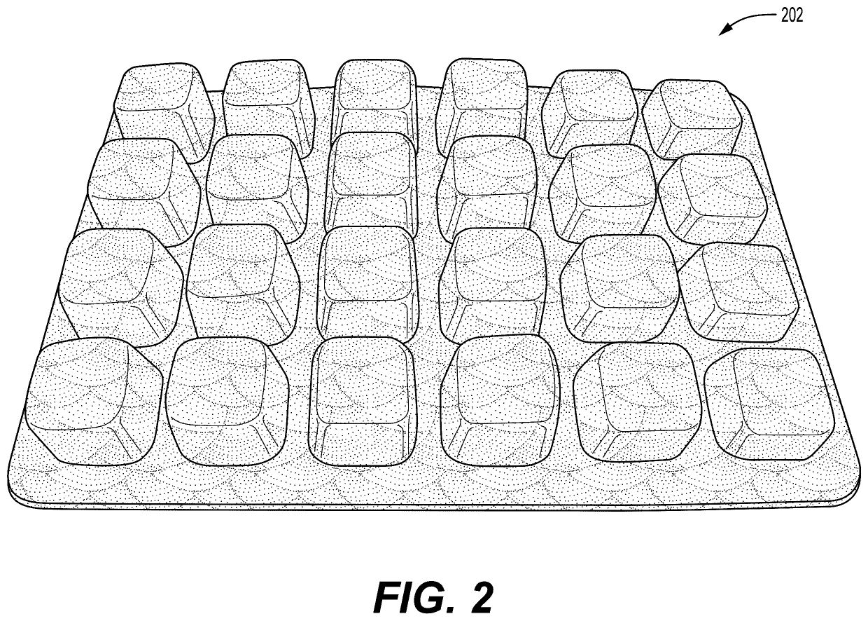

Referring to FIG. 2, a block 202 is shown. The block 202 may be a second material different from the first material of the mold 102. In an example, the block 202 is a foam block.

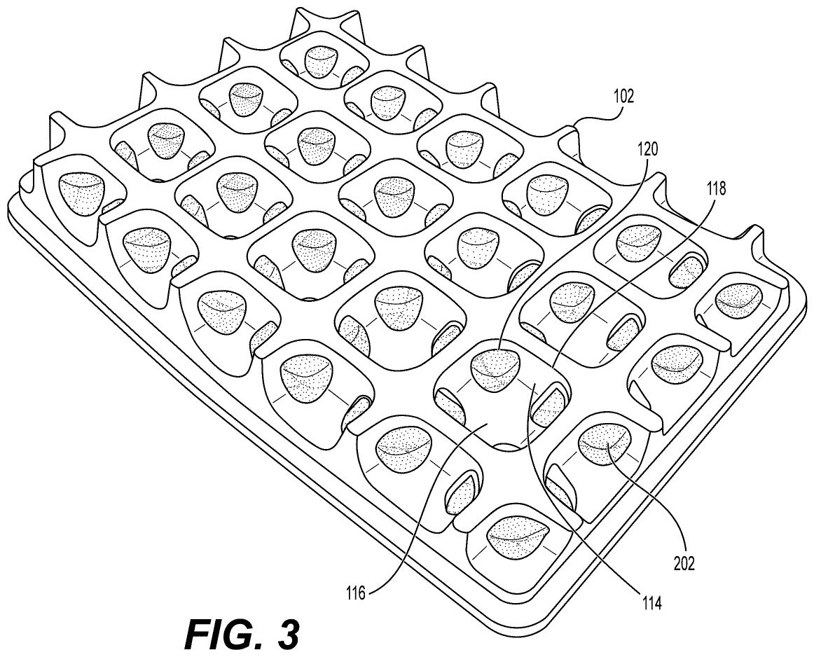

Referring to FIG. 3, the mold 102 is mated with the block 202. The mold 102 tapering from the first end 106a to the second end 106b allows the block 202 to better lock in place when mating the block 202 and the mold 102. Additionally, the block 202 is more easily removed from the mold 102 due to the taper of the mold 102, should the mold 102 and the block 202 need to be separated to adjust the block 202. As the block 202 and the mold 102 are mated or otherwise coupled, portions of the block 202 are compressed and extend through the openings 120 of the mold 102. As the mold 102 compresses the block 202, the footing 116 presses against portions of the block 202 such that portions of the block 202 extend through one or more of the openings 120. In other words, as the mold 102 and the block 202 are mated, each respective chamber 118 receives portions of the block 202 therein such that each of the respective posts 114 and footings 116 push portions of the block 202 out of the respective openings 120.

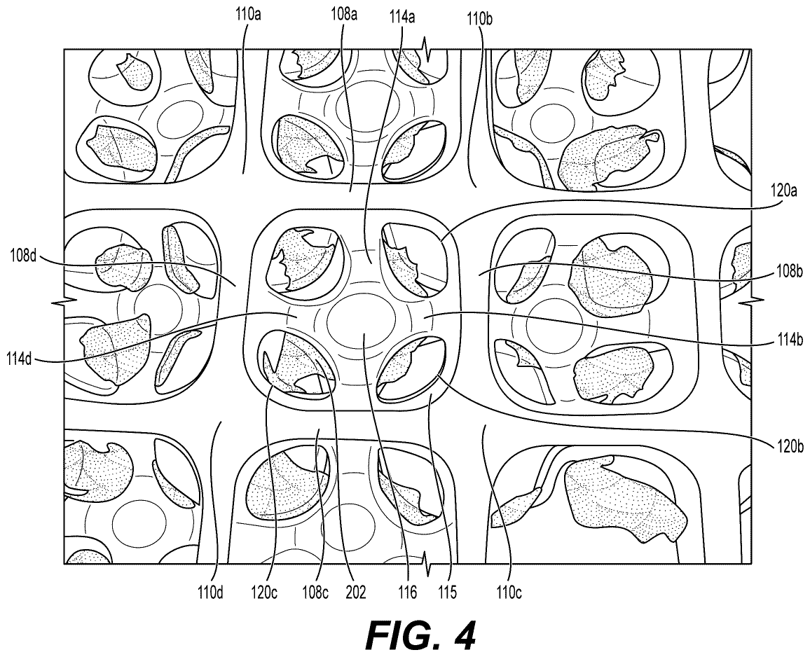

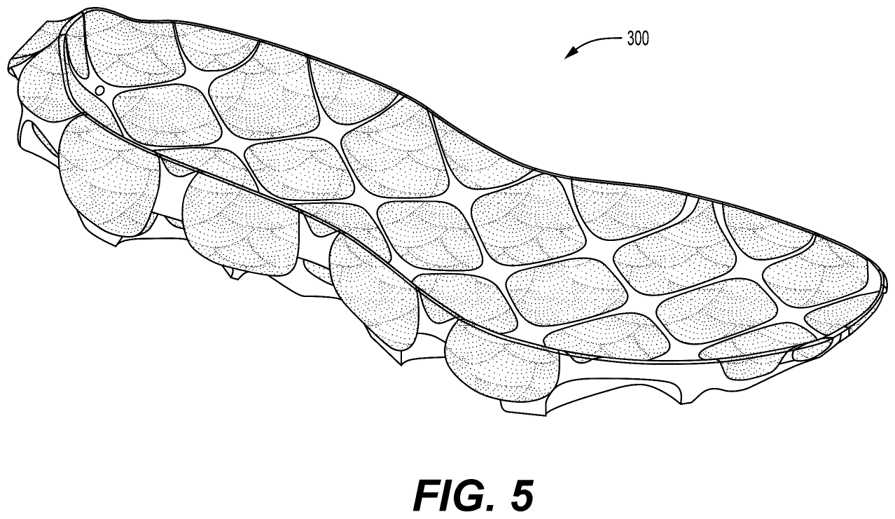

Referring to FIG. 4, zoomed in perspective view of the combination of the mold 102 and the block 202 is shown. In an example, the mold 102 and the block 202 may be heated and melted into a resultant sole structure 300, shown in FIG. 5. In some examples, the mold 102 and block 202 are stamped or otherwise cut into the sole structure 300 after the heating and melting occur. The sole structure 300 forms a 3D lattice shape where the first material and the second material are integrally formed in the sole structure 300.

The sole structure 300 molded using the mold 102 has a lower density and is lighter in weight while providing greater amounts of multi-zonal stiffness as compared to prior molded articles. For example, the articles molded by the disclosed process may include one or more zones of a desired level of cushioning. In some examples, the articles molded by the disclosed process may include three or more zones of a desired level of cushioning. In an example, the articles molded by the disclosed process includes five or more zones of a desired level of cushioning. This provides a more discrete desired form of cushioning and support when incorporated in articles of footwear. Prior articles of footwear could only incorporate at most four zones of a desired level of cushioning. For example, multi-zonal cushioning provides discrete cushioning areas to the sole structure 300 such as a stiff zone adjacent to a compliant zone. In the example, the stiff zones and the compliant zones provide a desired underfoot feel at a plurality of desired locations of cushioning along the sole structure 300. In such an example, a user of the sole structure 300 benefits from have a cushioned ride while still providing stability support when, for example, running, jogging, or walking. As another example, the sole structure 300 may be tuned or otherwise adapted based on a desired form of stiffness, flexibility, and/or cushioning as well as a desired location in one of the forefoot region 20, the mid-foot region 22, and the heel region 24 based on the desired stiffness, flexibility, and/or cushioning.

The molded article may be incorporated as cushioning into other articles. As nonlimiting examples, the molded article may be a foam element in footwear, such as a part of a footwear upper, such as a foam element in a collar, a foam midsole or a part of a midsole, or an outsole or a part of an outsole; foam padding in shinguards, shoulder pads, chest protectors, masks, helmets or other headgear, knee protectors, and other protective equipment; padding in a padded strap, for example for a golf bag or shoulder bag; an element placed in an article of clothing between textile layers; or may be used for other known padding applications for protection or comfort, especially those for which weight of the padding is a concern.

In various examples, the molded article is a midsole for an article of footwear. A midsole provides cushioning in the footwear. A midsole should be durable but also preferably adds as little weight as possible to the footwear while still cushioning to the desired degree. A midsole also should be able to be bonded to an outsole, an upper, or any other components (e.g., a shank, an airbag, or decorative components) in making an article of footwear.

In other examples, the molded article is an outsole for an article of footwear. An outsole may be molded using a rigid thermoplastic polyurethane.

Example materials may include those based on foaming or molding material, e.g., a resilient material, comprising one or more polymers, such as one or more elastomers (e.g., thermoplastic elastomers (TPE)). The one or more polymers may include aliphatic polymers, aromatic polymers, or mixtures of both; and may include homopolymers, copolymers (including terpolymers), or mixtures of both.

In some aspects, the material is a thermoplastic material when it is combined with other elements to make the midsole, sole structure, or article of footwear, and remains thermoplastic, and is a thermoplastic material in the final product (e.g., in the finished midsole, finished sole structure or finished article of footwear). In other aspects, the material is a thermoplastic material when it is combined with other elements to make the midsole, sole structure, or article of footwear, and is subsequently cured into a crosslinked material in the manufacturing process, and thus is a crosslinked material in the final product. In yet other aspects, the material is crosslinked before being combined with other elements of the midsole, sole structure or article of footwear during the manufacturing process, and thus is a crosslinked material in the final product.

In some aspects, the one or more polymers may include olefinic homopolymers, olefinic copolymers, or blends thereof. Examples of olefinic polymers include polyethylene, polypropylene, and combinations thereof. In other aspects, the one or more polymers may include one or more ethylene copolymers, such as, ethylene-vinyl acetate (EVA) copolymers, EVOH copolymers, ethylene-ethyl acrylate copolymers, ethylene-unsaturated mono-fatty acid copolymers, and combinations thereof.

In further aspects, the one or more polymers may include one or more polyacrylates, such as polyacrylic acid, esters of polyacrylic acid, polyacrylonitrile, polyacrylic acetate, polymethyl acrylate, polyethyl acrylate, polybutyl acrylate, polymethyl methacrylate, and polyvinyl acetate; including derivatives thereof, copolymers thereof, and any combinations thereof.

In yet further aspects, the one or more polymers may include one or more ionomeric polymers. In these aspects, the ionomeric polymers may include polymers with carboxylic acid functional groups, sulfonic acid functional groups, salts thereof (e.g., sodium, magnesium, potassium, etc.), and/or anhydrides thereof. For instance, the ionomeric polymer(s) may include one or more fatty acid-modified ionomeric polymers, polystyrene sulfonate, ethylene-methacrylic acid copolymers, and combinations thereof.

In further aspects, the one or more polymers may include one or more styrenic block copolymers, such as acrylonitrile butadiene styrene block copolymers, styrene acrylonitrile block copolymers, styrene ethylene butylene styrene block copolymers, styrene ethylene butadiene styrene block copolymers, styrene ethylene propylene styrene block copolymers, styrene butadiene styrene block copolymers, and combinations thereof.

In further aspects, the one or more polymers may include one or more polyamide copolymers (e.g., polyamide-polyether copolymers) and/or one or more polyurethanes (e.g., crosslinked polyurethanes and/or thermoplastic polyurethanes). Alternatively, the one or more polymers may include one or more natural and/or synthetic rubbers, such as polybutadiene and polyisoprene.

In one aspect, the resilient material is a foam. When the material is foamed, the resilient material may be foamed using a physical blowing agent which phase transitions to a gas based on a change in temperature and/or pressure, or a chemical blowing agent which forms a gas when heated above its activation temperature. For example, the chemical blowing agent may be an azo compound such as adodicarbonamide, sodium bicarbonate, and/or an isocyanate.

In some embodiments, the foam may be a crosslinked foam. In these embodiments, a peroxide-based crosslinking agent such as dicumyl peroxide may be used. Furthermore, the foam may include one or more fillers such as pigments, modified or natural clays, modified or unmodified synthetic clays, talc glass fiber, powdered glass, modified or natural silica, calcium carbonate, mica, paper, wood chips, and the like.

In another example, when the resilient material is a foam, the material may be foamed during a molding process, such as an injection molding process. A thermoplastic material may be melted in the barrel of an injection molding system and combined with a physical or chemical blowing agent and optionally a crosslinking agent (in order to make a crosslinked foam), and then injected into a mold under conditions which activate the blowing agent, forming a molded foam.

Optionally, when the resilient material is a foam, the foam may be a compression molded foam. Compression molding may be used to alter the physical properties (e.g., density, stiffness and/or durometer) of a foam, or to alter the physical appearance of the foam (e.g., to fuse two or more pieces of foam, to shape the foam, etc.), or both.

The block 202 disclosed herein may comprise, consist essentially of, or consist of one or more polymeric materials. Accordingly, the polymeric materials described herein are understood to comprise, consist essentially of, or consist of one or more polymers. All the one or more polymers present in a polymeric material constitute the polymeric component of the polymeric material. Similarly, when a polymeric material comprises one or more non-polymer additives, all of the non-polymer additives present in the polymeric material constitute the non-polymeric component of the polymeric material. The polymeric material may be a thermoplastic material, in which the one or more polymers of the polymeric material comprises, consists essentially of, or consists of one or more thermoplastic. A thermoplastic is a polymer that is a solid when cooled, and which can be repeatedly softened and melted on heating. The polymeric material may be an elastomeric material, in which the one or more polymers of the elastomeric material comprises, consists essentially of, or consist of one or more elastomer. An elastomer is a polymer having an elongation at break of greater than 100 percent, such as of greater than 200 percent, or of greater than 400 percent, as determined using ASTM D-412-98 at 25 degrees Celsius. An elastomeric material is a composition having an elongation at break of greater than 100 percent, such as of greater than 200 percent, of or greater than 400 percent, as determined using ASTM D-412-98 at 25 degrees Celsius.

The one or more polymers of a polymeric material may include one or more of a variety of polymers, including homopolymers and copolymers and combinations of homopolymers and copolymers. The one or more polymers may comprise, consist essentially of, or consist of a polymer chosen from a polyurethane, a polyurea, a polyester, a polyether, a polyamide, a polyimide, a polyolefin, a polystyrene, a polysilane, a polysiloxane, a polycarbonate, a polyacetate, including homopolymers and copolymers thereof, and any combination thereof. The one or more polymers may comprise, consist essentially of, or consist of a polymer chosen from a polyurethane, a polyester, a polyamide, a polystyrene, a polyolefin, including homopolymers and copolymers thereof, and any combination thereof. The one or more polymers may comprise, consist essentially of, or consist of one or more polyurethane. Examples of polyurethanes include thermoplastic polyurethanes (TPUs), such as polyester-polyurethane copolymers and polyether-polyurethane copolymers, including thermoplastic elastomeric polyurethanes. The one or more polymers may comprise, consist essentially of, or consist of one or more polyester. Examples polyesters include polyester homopolymers such as polyethylene terephthalate (PET), and polyester copolymers such as polyetheresters, including thermoplastic polyester copolymers. The one or more polymers may comprise, consist essentially of, or consist of one or more polyamide. Examples of polyamide homopolymers include thermoplastic polyamide homopolymers such as Nylon-6, Nylon-6,6, and Nylon-11. Examples of polyamide copolymers include thermoplastic polyamide copolymers such as thermoplastic elastomeric polyamide block copolymers, for example polyether block amide (PEBA) thermoplastic elastomers. The one or more polymers may comprise, consist essentially of, or consist of one or more polystyrene. The one or more polystyrene may comprise, consist essentially of, or consist of thermoplastic polystyrene homopolymers, for example one or more thermoplastic polystyrene homopolymers. Examples of polystyrenes also include polystyrene copolymers such as thermoplastic polystryrene copolymers and thermoplastic polystyrene copolymer elastomers. Examples of polystyrene copolymers include styrene-butadiene-styrene (SBS) copolymers and styrene-ethylene-butadiene-styrene (SEBS) copolymers. The one or more polymers may comprise, consist essentially of, or consist of one or more polyolefin. The one or more polyolefin may comprise, consist essentially of, or consist of one or more thermoplastic polyolefin, for example one or more thermoplastic polyolefin elastomer, including one or more thermoplastic polyolefin homopolymer elastomer, or one or more thermoplastic polyolefin copolymer elastomer, or a combination of both. Examples of polyolefin homopolymers include polyethylene and polypropylene. Examples of polyolefin copolymers include copolymers comprising two olefinic monomeric units, such as polyethylene-polypropylene copolymers, as well as copolymers comprising one olefinic monomeric unit, such as ethylene-vinyl acetate copolymers (EVA) and ethylene-vinyl alcohol (EVOH) copolymers.

The polymeric material may comprise from about 5 weight percent to about 100 weight percent of the polymeric component based on a total weight of the polymeric material. The polymeric component can comprise from about 15 weight percent to about 100 weight percent, from about 30 weight percent to about 100 weight percent, from about 50 weight percent to about 100 weight percent, or from about 70 weight percent to about 100 weight percent of the polymeric material. When the polymeric material comprises a non-polymeric component, the non-polymeric component may comprise from about 1 weight percent to about 20 weight percent, or from about 1 weight percent to about 10 weight percent, or from about 1 weight percent to about 5 weight percent based on a total weight of the polymeric material. As used herein, the terms “consist essentially of”, “consists essentially of” and “consisting essentially of” refer to compositions which consist of less than 1 weight percent of materials other than those recited, based on a total weight of the composition. For example, “a polymeric material consisting essentially of thermoplastics” is understood to be a polymeric material which included less than 1 weight percent of non-thermoplastic polymers and non-polymeric materials; while “a polymeric material comprising a polymeric component consisting essentially of thermoplastics” is understood to include a polymeric component in which less than 1 weight percent of the polymers present are non-thermoplastic polymers, but this polymeric material may include more than 1 weight percent of non-polymeric materials.

The polymeric material may be a material which polymerizes or crosslinks or both polymerizes and crosslinks during the process of forming the component or during the process of forming the sole structure. The polymerization or crosslinking may be initiated by including a chemical polymerization or crosslinking initiator in the polymeric material (e.g., a chemical which initiates polymerization or crosslinking reactions within the polymeric material when it is exposed to thermal energy, UV light, or another form of actinic radiation), or the polymerization or crosslinking may be initiated by mixing together two compositions which react to produce polymerization or crosslinking reactions, or by exposing a polymeric material to a form of actinic radiation in sufficient quantity to polymerize pre-polymers or oligomers present in the exposed material, or to crosslink polymers present in the exposed polymeric material. In compositions in which polymerization occurs, the material may initially comprise one or more pre-polymers or oligomers which react and polymerize during the manufacturing process, resulting in a support or sole structure comprising the reacted polymeric material. In compositions in which crosslinking occurs, the material may initially comprise one or more crosslinkable pre-polymers, oligomers, or polymers which react with crosslinking agents or crosslinking energy and form crosslinked polymers during the manufacturing process, resulting in a component or sole structure comprising a crosslinked polymeric material. The resulting reacted polymeric material may be a thermoset material. Similarly, the initial polymeric material may be a thermosetting thermoplastic material (e.g., a polymeric material which comprises one or more thermoplastics and a crosslinking agent before it is thermally processed), with the resulting crosslinked polymeric material being a thermoset material (e.g., after the crosslinking agent reacts with the thermoplastics and crosslinks them, and the resulting thermoset material solidifies). One example of this is a thermosettable molten thermoplastic material comprising a thermally-activated crosslinking agent and a foaming agent, where the thermally-activated crosslinking agent is activated during a foaming process, producing in a thermoset foam material.

Optionally, the polymeric material may comprise one or more additives. Examples of additives include fillers, polymerization initiators, crosslinking agents, UV light absorbers, anti-oxidants, processing aids such as lubricants and plasticizers, and colorants, such as pigments and dyes. Fillers may include non-polymeric fillers such as silica, clay, and titanium dioxide. Fillers may include polymeric fillers such as polymeric fibers and finely-ground polymeric powders, including ground thermoset rubber. Colorants such as naturally-occurring and synthetic pigments and dyes may be used. The polymeric material may comprise one or more additives at a concentration of from about 0.1 weight percent to about 20 weight percent, or from about 0.2 weight percent to about 10 weight percent, or from about 0.5 weight percent to about 5 weight percent, based on a total weight of the polymeric material.

The polymeric material may be a solid polymeric material, meaning that the polymeric material is unfoamed. The solid polymeric material may be an extruded material, which results in the component comprising the extruded material being an extruded component, such as an extruded film or sheet. The solid polymeric material may be a molded material, which results in the component comprising the molded material being a molded component. Various methods may be used, including compression molding and injection molding. For example, the solid polymeric material may be an injection molded material, which results in the component comprising the injection molded material being an injection molded component.

The polymeric material may be a foamed polymeric material, meaning that the polymeric material has a multi-cellular foam structure. The foamed polymeric material may have an open-cell structure, meaning that the majority of the cells of the multi-cellular foam are open cells. Alternatively, the foamed polymeric material may have a closed-cell structure, meaning that the majority of the cells of the multi-cellular foam are closed cells.

The following clauses provide an exemplary configuration for an article of footwear and sole structure described above.

Clause 1: A mold for manufacturing a sole structure for an article of footwear comprising:
a first end and a second end opposite the first end;
a first edge and a second edge disposed opposite the first edge; and
a plurality of chambers surrounding one or more cavities, wherein the plurality of chambers extend from the first end to the second end and from the first edge to the second edge.

Clause 2. The mold of clause 1, wherein each of the plurality of chambers includes:
one or more bases;
one or more ribs connected between the one or more bases;
a footing; and
one or more posts coupled with the footing and the one or more ribs.

Clause 3. The mold of clause 1, wherein an opening is disposed between adjacent posts of the one or more posts.

Clause 4. The mold of clause 1, wherein the plurality of chambers include a first surface surrounding the one or more cavities, and wherein the plurality of chambers include a second surface disposed opposite the first surface, the second surface being a rounded surface of the mold.

Clause 5. The mold of clause 1, wherein the plurality of chambers are configured to engage portions of a block.

Clause 6. The mold of clause 1, wherein the plurality of chambers includes one or more partial chambers disposed along an outer periphery of the mold.

Clause 7. The mold of clause 1, wherein the mold tapers from the first end to the second end such that the second end is disposed in a plane that is offset from a plane of the first end.

Clause 8. The mold of clause 7, wherein one or more chambers disposed adjacent the first end are disposed in a plane offset from a plane of one or more chambers disposed adjacent the second end.

Clause 9. The mold of clause 1, wherein the plurality of chambers extend away from a first surface of the mold.

Clause 10. A mold for manufacturing a sole structure for an article of footwear comprising:
a first end and a second end opposite the first end, wherein the mold tapers from the first end to the second end;
a first edge and a second edge disposed opposite the first edge; and
a plurality of chambers extending from the first end to the second end and the first edge to the second edge surrounding a plurality of cavities, the plurality of chambers including one or more ribs extending between one or more bases and the plurality of chambers including one or more posts extending from the one or more ribs to a footing.

Clause 11. The mold of clause 10, wherein an opening is disposed between adjacent posts of the one or more posts.

Clause 12. The mold of clause 11, wherein the opening is circular in shape.

Clause 13. The mold of clause 10, wherein the one or more ribs include a first rib, a second rib, a third rib, and a fourth rib, the one or more bases includes a first base, a second base, a third base, and a fourth base, wherein the first rib extends between the first base and the second base, the second rib extends between the second base and the third base, the third rib extends between the third base and the fourth base, and the fourth rib extends between the fourth base and the first base.

Clause 14. The mold of clause 13, wherein one or more posts includes a first post extending from the first rib to the footing, a second post extending from the second rib to the footing, a third post extending from the third rib to the footing, and a fourth post extending from the fourth rib to the footing.

Clause 15. The mold of clause 10, wherein the plurality of chambers are rounded.

Clause 16. The mold of clause 10, wherein the plurality of chambers extend away from a first surface of the mold.

Clause 17. The mold of clause 10, wherein one or more chambers disposed at an outer periphery of the mold are partial chambers.

Clause 18. The mold of clause 17, wherein the partial chambers include interior portions exposed to an external environment.

Clause 19. The mold of clause 10, wherein one or more chambers disposed adjacent the first end are disposed in a plane offset from a plane of one or more chambers disposed adjacent the second end.

Clause 20. The mold of clause 10, wherein the mold is comprised of a foamed material.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

We claim:

1. A mold for manufacturing a sole structure for an article of footwear comprising:
a first end and a second end opposite the first end;
a first edge and a second edge disposed opposite the first edge; and
a plurality of chambers surrounding one or more cavities, wherein the plurality of chambers extend from the first end to the second end and from the first edge to the second edge.

2. The mold of claim 1, wherein each of the plurality of chambers includes:
one or more bases;
one or more ribs connected between the one or more bases;
a footing; and
one or more posts coupled with the footing and the one or more ribs.

3. The mold of claim 1, wherein an opening is disposed between adjacent posts of the one or more posts.

4. The mold of claim 1, wherein the plurality of chambers include a first surface surrounding the one or more cavities, and wherein the plurality of chambers include a second surface disposed opposite the first surface, the second surface being a rounded surface of the mold.

5. The mold of claim 1, wherein the plurality of chambers are configured to engage portions of a block.

6. The mold of claim 1, wherein the plurality of chambers includes one or more partial chambers disposed along an outer periphery of the mold.

7. The mold of claim 1, wherein the mold tapers from the first end to the second end such that the second end is disposed in a plane that is offset from a plane of the first end.

8. The mold of claim 7, wherein one or more chambers disposed adjacent the first end are disposed in a plane offset from a plane of one or more chambers disposed adjacent the second end.

9. The mold of claim 1, wherein the plurality of chambers extend away from a first surface of the mold.

10. A mold for manufacturing a sole structure for an article of footwear comprising:
a first end and a second end opposite the first end, wherein the mold tapers from the first end to the second end;
a first edge and a second edge disposed opposite the first edge; and
a plurality of chambers extending from the first end to the second end and the first edge to the second edge surrounding a plurality of cavities, the plurality of chambers including one or more ribs extending between one or more bases and the plurality of chambers including one or more posts extending from the one or more ribs to a footing.

11. The mold of claim 10, wherein an opening is disposed between adjacent posts of the one or more posts.

12. The mold of claim 11, wherein the opening is circular in shape.

13. The mold of claim 10, wherein the one or more ribs include a first rib, a second rib, a third rib, and a fourth rib, the one or more bases includes a first base, a second base, a third base, and a fourth base, wherein the first rib extends between the first base and the second base, the second rib extends between the second base and the third base, the third rib extends between the third base and the fourth base, and the fourth rib extends between the fourth base and the first base.

14. The mold of claim 13, wherein one or more posts includes a first post extending from the first rib to the footing, a second post extending from the second rib to the footing, a third post extending from the third rib to the footing, and a fourth post extending from the fourth rib to the footing.

15. The mold of claim 10, wherein the plurality of chambers are rounded.

16. The mold of claim 10, wherein the plurality of chambers extend away from a first surface of the mold.

17. The mold of claim 10, wherein one or more chambers disposed at an outer periphery of the mold are partial chambers.

18. The mold of claim 17, wherein the partial chambers include interior portions exposed to an external environment.

19. The mold of claim 10, wherein one or more chambers disposed adjacent the first end are disposed in a plane offset from a plane of one or more chambers disposed adjacent the second end.

20. The mold of claim 10, wherein the mold is comprised of a foamed material.
